(19) United States
(12) Patent Application Publication
(10) Pub. No.: US 2012/0313343 A1
(43) Pub. Date: Dec. 13, 2012

(54) BALL MOUNT STEP PLATFORM

(76) Inventor: BRYAN FLETCHER, Lodi, CA (US)

(21) Appl. No.: 13/157,699

(22) Filed: Jun. 10, 2011

(51) Int. Cl. B60R 3/00

(52) U.S. Cl. 280/164.1

(57) ABSTRACT

A step platform that can be used safely for access to a vehicle rear roof or storage compartment, in conjunction with a ball mount and receiver hitch to allow for towing.

### BACKGROUND

Many pick-up trucks, sport utility vehicles (SUV), and passenger vehicles often have a rear compartment or roof area that are designed for use of storage, or may include a top-load storage device, such as a bike rack, ski rack, cargo box, and the like. The clearance from the ground to the deck of the rear roof or truck storage area may be as high as seven feet or more, making it difficult to reach from the ground. While this may be inconvenient for individuals who want to reach such storage or compartment areas, such a clearance also can make loading such areas difficult and dangerous.

To compensate for the height, and to reach these vehicle storage areas, individuals may climb up onto the vehicle bumper or tire to gain access. This approach is dangerous and unstable. The chance of slipping off of the bumper or tire while attempting such a reach is great. Short of carrying a step-ladder in the vehicle, individuals who want to use the full access to the storage area cannot presently do so without risk of injury.

Many trucks, SUV's, and cars include a hitch receiver attached to the rear of the vehicle, used for towing a trailer or carrying an accessory, such as a bike rack. For purposes of towing, a ball mount typically is inserted into the hitch receiver tube, which usually is located under the vehicle rear bumper. The ball mount shank slides into the hitch receiver tube, and is secured by receiver pins or receiver locks. There are many existing steps that disclose a receiver hitch mounted step to provide access to the rear of the vehicle; however, these steps interfere with the user's ability to have the step in place together with a ball mount to allow for towing. There are only a few step designs that allow the use of the receiver hitch for towing. These designs consist of mounting the step between the trailer ball and the ball mount. This design can be unsafe, because use of the step may result in loosening the ball from the ball mount, leading to an accident and injury.

Thus, there remains a need for a step platform that can be used safely for access to a vehicle rear roof or storage compartment, in conjunction with a ball mount and receiver hitch to allow for towing.

### SUMMARY

The step platform of the present invention includes a step platform, with a top surface and a bottom surface. In an embodiment, the step platform is mountable on a ball mount shank, which shank extends along a ball mount axis and is characterized by a rectangular cross-section. The platform element has a substantially planar upper surface portion and a substantially planar lower surface portion. The embodiment further includes a coupling assembly extending from the lower surface portion and defining an aperture extending along a platform axis, that is substantially parallel to the lower surface portion. The aperture, as so defined, is characterized by a substantially rectangular cross-section transverse to the platform axis, which rectangle may be a square. The aperture cross-section is substantially similar to the shank cross-section, to allow the aperture to slide over the shank. Thus, the coupling assembly is selectively, slidably positionable over and about the shank, with the platform axis substantially parallel with the ball mount axis. The aperture may include a hole in one side of the aperture, which allows for a bolt or other securing device to pass through the hole and secure the platform to the ball mount shank.

In another embodiment, the couple assembly includes a first extension bracket extending from and perpendicular to the lower surface portion to a distal end, and the assembly has a substantially planar first principal surface. The embodiment includes a second extension bracket that extends from and is perpendicular to the lower surface portion to a distal end. The second extension bracket has a substantially planar first principal surface. The first principal surface of the first extension bracket is opposite the first principal surface of the second extension bracket, and the distal end of the first extension bracket and the distal end of the second extension bracket are equidistant from the lower surface portion. This embodiment further includes a transverse bracket having a substantially planar first principal surface spanning the distal end of the first extension bracket and the distal end of the second extension bracket. In this embodiment, the first principal surface of the first extension bracket, the first principal surface of the second extension bracket, and the first principal surface of the transverse bracket and the lower surface portion define the aperture.

In yet another embodiment, a rigid, shaped platform element, having a top surface and a bottom surface, extends along a horizontal axis HA. The platform element includes two extension brackets attached to the bottom surface, which brackets extend substantially perpendicular to the horizontal axis. A third connector bracket extends between, and is connected to, the two extension brackets to define an aperture approximately shaped to receive a ball mount shank. In this way, the step platform is slidable over the distal insertion end of the ball mount shank. Once the step platform is in position over the ball mount shank, the distal end protrudes a distance beyond the aperture, so that it can be inserted into the hitch receiver tube attached to a motor vehicle.

In alternate embodiments, the shaped platform is substantially in the shape of a half-circle. The top surface may include a grip-enhancing surface, such as a grooved surface or the application of a roughening material. In an embodiment, the extension brackets may be integral with or formed from the bottom surface, or attached using standard attachment devices. In another embodiment, one or both of the extension brackets are hinged to the bottom surface to allow the aperture to be opened and closed around the ball mount shank, instead of sliding over the shank.

In yet another embodiment, the step platform is formed from a single block of rigid material having a shape that corresponds to the shape of the top platform surface. The block includes a bore hole extending along the horizontal axis HA, and having a shape that approximately corresponds to the shape of the ball mount shank over which the platform slides.

In yet another embodiment, the step platform is fixedly attached to a ball mount shank, positioned such that the platform edges do not interfere with either insertion of the shank into the hitch receiver tube or the ball mount. More specifically, this embodiment of a step assembly fixedly attached to a ball mount assembly includes a shaped step element having a top surface and a bottom surface and a ball mount assembly, having a top surface and a bottom surface. The ball mount assembly includes a ball mount shank extending along a horizontal axis, having a distal insertion end and a proximal mount end, and a ball mount element attached to the ball mount shank proximal mount end, and extending along the horizontal axis. The shaped step element bottom surface is fixedly attached to the ball mount assembly top surface and at least one of the ball mount shank and the ball mount element, along an axis transverse the horizontal axis. Further, the shaped step element is positioned on the ball mount assembly in a location that does not interfere with full utility of the ball mount assembly.

The present device is more fully described in the figures and detailed description below.

### BRIEF DESCRIPTION OF THE FIGURES

FIG. 1A is a top perspective view of an embodiment of the step platform described herein.

FIG. 1B is a perspective view of an alternative embodiment of the step platform.

FIG. 1C is an perspective view of an alternative embodiment of the step platform.

FIG. 2 is a front cross-section view of an embodiment of the step platform described herein.

FIG. 3 is a top plan view of an embodiment of the step platform described herein, showing an embodiment of the top surface.

FIG. 4 is a cross-section view, through plane A-A of FIG. 2, of an embodiment of the step platform described herein.

FIG. 5 shows how a step platform is inserted over the distal end of a ball mount shank, with a hitch receiver tube into which the distal end of the ball mount shank is thereafter inserted.

FIG. 6 is an embodiment of the step platform positioned on a ball mount shank, which ball mount is positioned in a hitch receiver tube of an automobile.

FIG. 7 is a side perspective view of an alternative embodiment of the step platform, wherein the step platform is formed from a single block of rigid material.

FIG. 8 is a side perspective view of an alternative embodiment of the step platform, wherein the step platform is permanently affixed to the top of the ball mount shank.

FIG. 9 is a top plan view of the alternative embodiment of FIG. 8, wherein the step platform is permanently affixed to the top of the ball mount shank.

### DETAILED DESCRIPTION

The present device relates to a novel step platform that slidably mounts on a trailer hitch ball mount, allowing a user to have safe, convenient access to a vehicle rear roof or truck bed. Alternatively, the step platform is permanently affixed to the trailer hitch ball mount. There are several embodiments of this step platform, as described in further detail below and in conjunction with the figures.

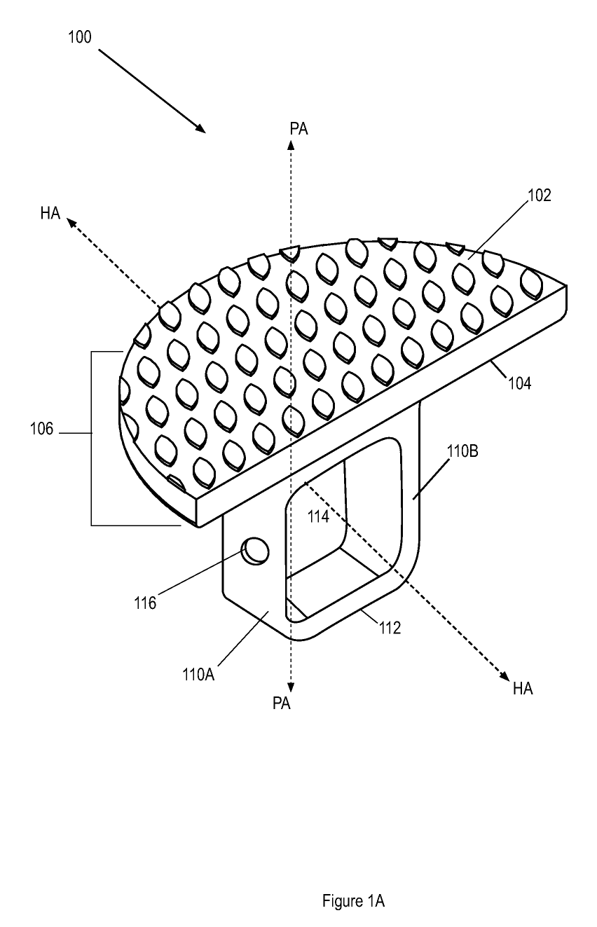

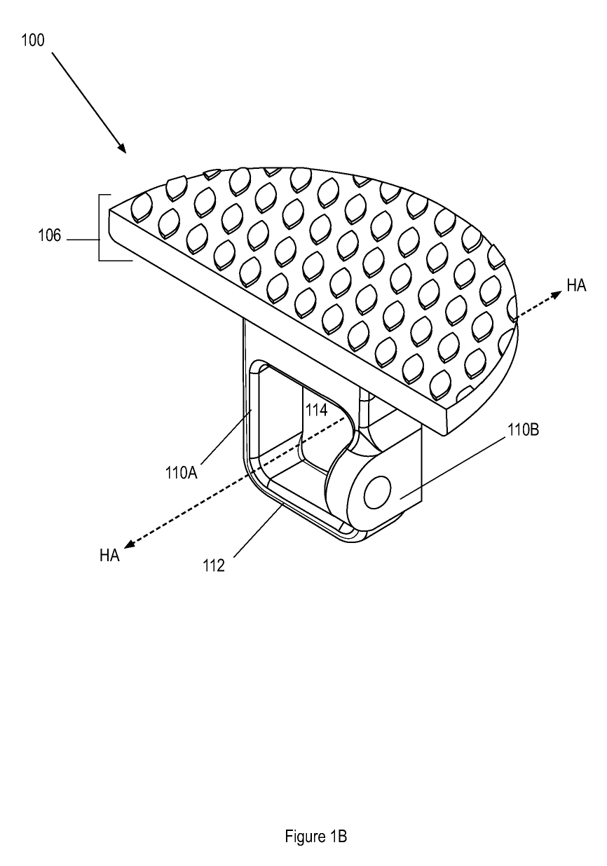

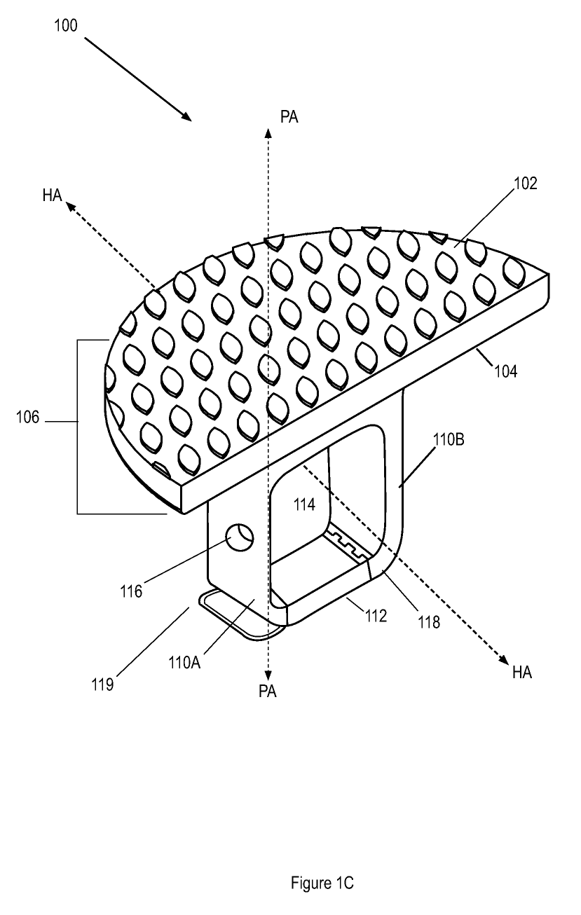

An embodiment of the present step platform 100 is shown in FIG. 1A. The step platform 100 includes a top surface portion 102 and a corresponding bottom surface portion 104. The top and bottom portions define the platform element 106, which extends along a horizontal axis HA. Attached to the platform element 106 are two extension brackets 110a, 110b, that extend along an axis PA that is essentially perpendicular to the horizontal axis HA.

The extension brackets 110a, 110b are manufactured from a rigid material, preferably a strong metal such as steel, aluminum, or any rigid plastic or composite material that can withstand significant pressure. The extensions brackets 110a, 110b are affixed to the bottom surface portion 104 by welding, screws, or other fixation means, or may be formed using methods such as casting. In one embodiment, the extension brackets 110a, 110b are integral with the bottom surface portion. Any method of securely fixing the extension brackets to the platform element may be used to construct the present step platform.

As further shown in FIG. 1A and FIG. 1B, the step platform includes a third connector bracket 112 extending between the two extension brackets 110A, 110B to form an aperture 114. The aperture extends along the horizontal axis HA, and is shaped to approximate the shape of the ball mount shank (not shown in this figure), over which the aperture fits. Because most standard ball mount shanks are typically of three standard sizes, the aperture 114 of the step platform 100 preferably has dimensions of 2 inches×2 inches, 2.5 inches×2.5 inches, or, 1.25 inches×1.25 inches to accommodate such sizes. However, as can be appreciated, the aperture shape may be different dimensions or shapes, including without limitation round, oval, rectangular (including square), or any other geometric or asymmetrical shape necessary to accommodate various shanks, tubes, and other towing devices on which the user desires to mount the step platform 100.

The connector bracket 112 preferably is manufactured from the same material as the extension brackets, but can be from a different material. The connector bracket 112 can be made from material that is not as strong as either the platform element or the extension brackets, because it is non-weight-bearing.

In an alternative embodiment, the extension brackets 110A, 110B and the connector bracket 112 are formed from a single piece of material, such as a rigid metal or plastic. In another alternative embodiment, and as shown in FIG. 1C discussed further below, either or both of the extension brackets can be hingeably attached to either the bottom surface 104 or to the connector bracket 112.

In the illustrated embodiment of FIG. 1A, at least one of the extension brackets 110 includes a small aperture 116 through which a pressure screw or other fixation device can be inserted. A screw is inserted through the extension bracket aperture 116 and presses against a shank that is extended through the step platform aperture 114. Because the shape of the step platform aperture 114 approximates the size and shape of the ball mount shank on which it is mounted, it is not necessary to include a pressure screw or other fixation device; however, most embodiments will include such an additional fixation device for additional safety and security.

FIG. 1C shows an alternative embodiment of the step platform 100 having a hinge element 118 positioned or integral with the intersection between one of the extension brackets (110B in the illustrated embodiment) and the connector bracket 112. A clasp element 119 is positioned at the intersection between the other extension bracket (110A in the illustrated embodiment) and the connector bracket 112. As shown, the hinge element 118 rotates to allow the connector bracket 112 to open along the bottom of the aperture 114 to allow the step platform 110 to be positioned about a ball mount shank (not shown). As may be understood, the hinge may be positioned at either intersection, or may be positioned between each of the extension brackets 110 and the bottom surface portion 104 of the platform element.

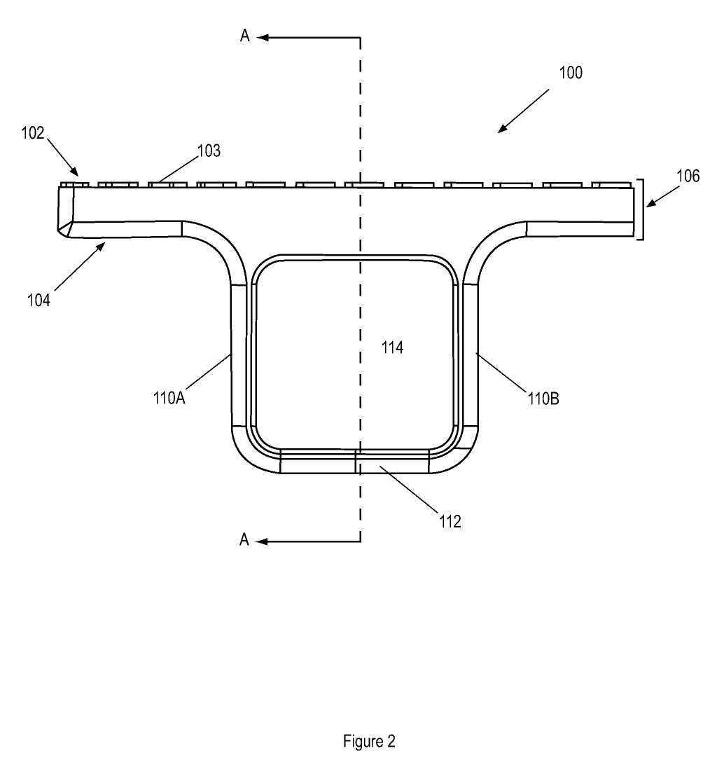

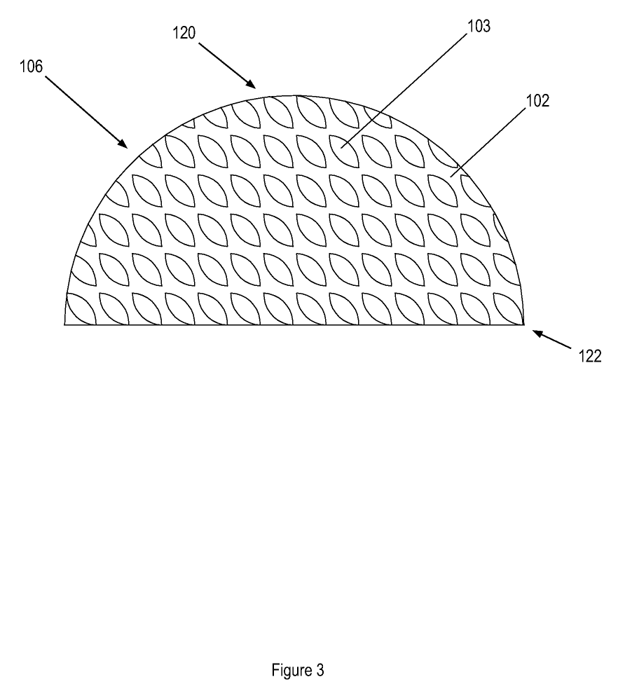

FIG. 2 shows a front cross-section view of the step platform 100. As shown, the platform element 106 includes a top surface portion 102 and a bottom surface portion 104. As further shown in FIG. 3, the top surface portion 102 may include some raised elements 103 that provide a rough surface to increase friction between the sole of the user's shoes and the top of the step platform. Several other methods and devices may be applied to the top surface 102 to increase the friction and hold, including, by way of example, grooves placed in the surface, rough materials affixed to the surface, and various raised elements to increase surface area.

In addition, and as shown in FIG. 3, the platform element 106 is shaped such that it has a protruding end 120 and a flush end 122. When the step platform 100 is in position, the protruding end 120 faces outward from the vehicle rear bumper to allow the user to stand on the platform as a step, i.e., away from the user, so that it extends under the vehicle and out of the way of the users and other devices that may be attached to the ball mount. Conversely, the flush end 122 is positioned, in a preferred embodiment, so that it is in line with the bumper, or proximal end of the vehicle. In this way, the user's foot extends on the step platform for secure footing without interference by the platform. The illustrated embodiment shown in FIG. 3 shows the platform element 106 as a semi-circle. However, a rectangle or other geometric shape may be used, while still providing a protruding end 120 that extends under the vehicle and a flush end 122 that does not extend under the vehicle.

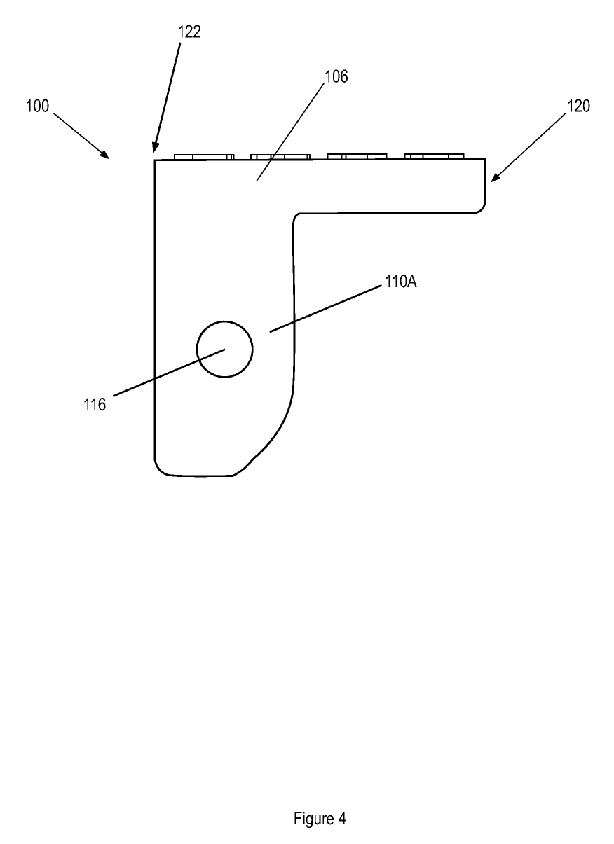

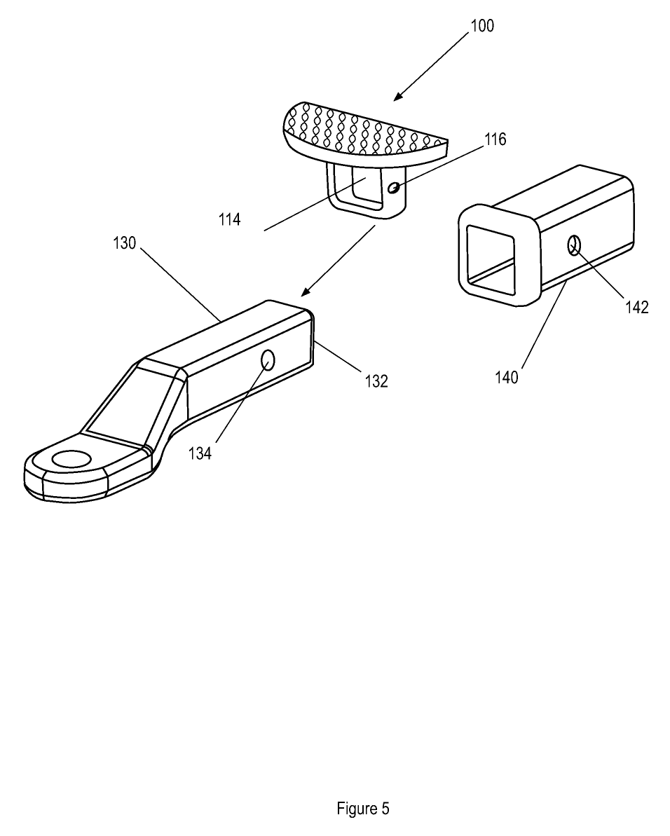

FIG. 4 is a cross-section, across axis A-A of FIG. 2, showing the protruding end 120 of the platform element 106. As shown, the platform element 106 extends beyond the width of the extension bracket 110a. In alternative embodiments, the extension bracket 110a extends the length of the protruding end 120 of the extension bracket. Also as shown in this FIG. 4, is the extension bracket aperture 116. The extension bracket aperture 116 is of a size to allow a bolt to pass through and secure the platform to the ball mount shank 130 (shown in FIG. 5) to reduce the risk of the step from moving during use.

In a preferred way of using the present step platform, and as shown in FIG. 5, the step platform 100 is inserted over the distal insertion end 132 of a ball mount shank 130 to be used with a vehicle receiver hitch. The shank 130 fits through the aperture 114 so that some of the shank 130 extends beyond the aperture 114 when fully deployed. In the illustrated embodiment, the shank 130 includes a divet or aperture 134; however, this aperture 134 does not align with the extension bracket aperture 116, but with a corresponding aperture 142 on the hitch receiver tube 140. Once the step platform 100 is in position on the shank 130, the distal end 130 then can be inserted into the proximal end of a hitch receiver tube 140, and secured. The hitch receiver tube 140 is either fixably attached to or otherwise mounted on a vehicle, typically beneath the bumper of such vehicle.

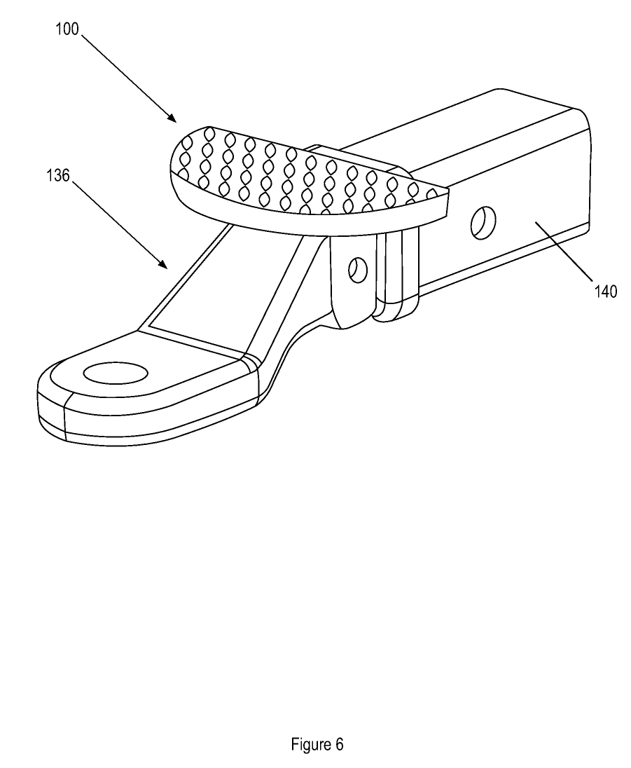

FIG. 6 shows a step platform 100 as assembled together with a ball mount hitch unit 136, which includes a ball mount shank (not shown), which is mounted in a hitch receiver tube 140.

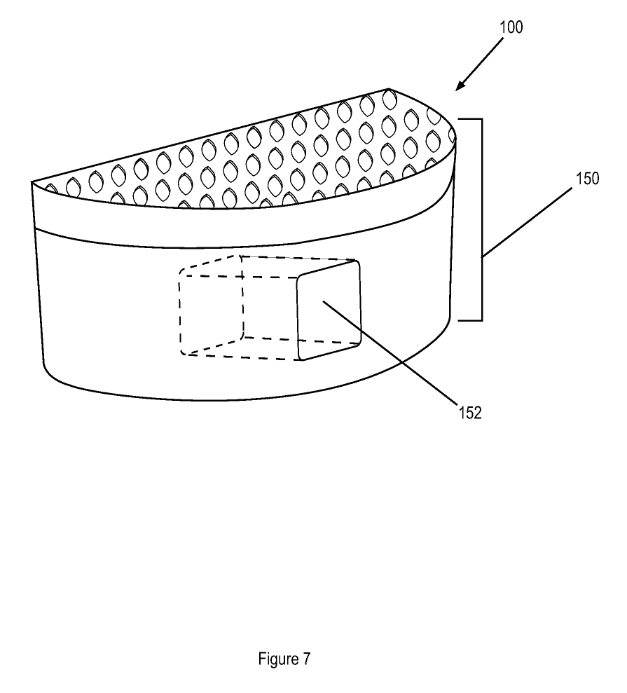

FIG. 7 shows another embodiment of the step platform 100 wherein the platform element, the extension brackets and the connector brackets are formed from a single platform block 150. In this illustrated embodiment, the block 150 includes a block aperture 152 having an external cross-section size and shape that correlates with the external cross-section size and shape of the shank onto which it is mounted. The aperture 152 extends along the horizontal axis HA. Block 150 can be molded, milled, casted, or otherwise formed from a single piece of rigid material, such as iron, steel, or other rigid metal, or a plastic or composite material that is sufficiently strong to support the weight of an individual.

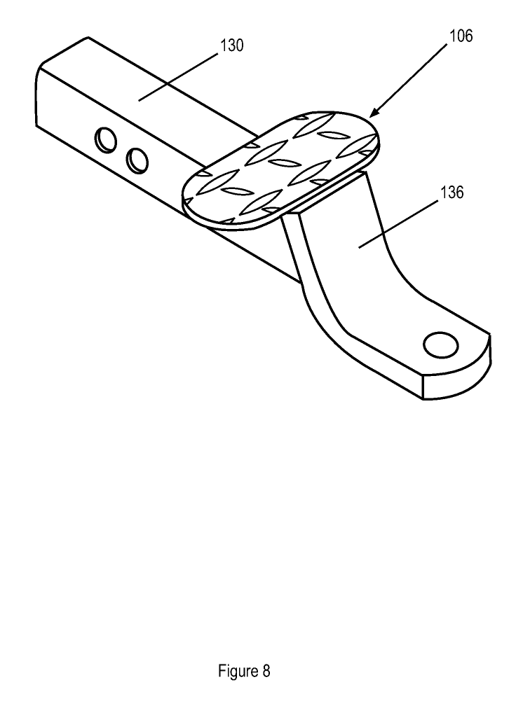

In yet another embodiment, and as shown in FIG. 8, the platform element 106 is fixedly attached along the ball mount shank 130. The platform element 106, as in the embodiments described above, may be cast or cut from a metal or rigid plastic, may be pressure molded or otherwise formed from a plastic or other rigid, durable synthetic or natural material. The platform element 106 may be attached to the shank 130 using any of the standard welding techniques for metals, including acid welding, or using any other available method or material to achieve a relatively permanent bond between the platform element and shank. Alternatively, the platform element 106 may be manufactured integral with the shank 130.

In the illustrated embodiment of FIG. 8, the platform element 106 is positioned across ball mount assembly 138, such that it extends over both the ball mount shank 130 and the ball mount element 136. In alternate embodiments, particularly when the entire ball mount assembly 138 having the step platform 106 is form molded or otherwise manufactured from a single material, the platform may be integral with both or only one portion of the assembly.

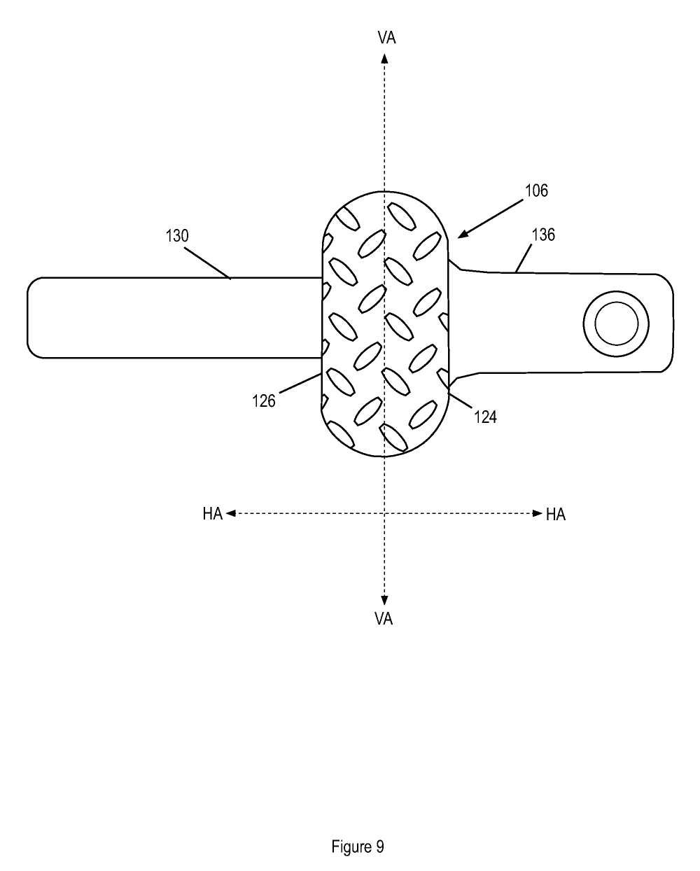

As shown in FIG. 9, the platform element 106 may be oval in shape, or any other shape that provides sufficient surface area for an individual to safely step, but not so much surface area that it interferes with the desired amount of insertion of the shank 130 into the hitch receiver tube 142 (not shown). It is important that the front proximal edge 124 of the platform 106 not extend too far along the ball mount hitch 136 to leave sufficient room to allow hook-up of a trailer or other accessory. Similarly, it is important that the back distal edge 126 of the platform 106 not extend too far back along the shank to cause interference with the vehicle bumper or frame. In a preferred embodiment, for a ball mount shank 130 that is the standard 2 inches wide, the preferred width of the platform element 106 along the horizontal axis HA of is 3 inches. The ball mount shank may also be other widths, including 2.5 and 1.25, or other widths as adapted by the industry. Also in a preferred embodiment, as shown in FIG. 9, the platform 106 is substantially oval in shape, and has a width along the vertical axis VA of 6 inches. However, other dimensions and shapes may be used, provided that neither the shape nor size interfere with the full functioning of the ball mount hitch 136.

As will be appreciated, various combinations of the features and methods described herein may be incorporated into a given system according to the invention. Accordingly, all combinations of the disclosed features and methods fall within the scope of this disclosure.

Although this invention has been described in terms of certain embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

I claim:

1. A step platform mountable on a ball mount shank extending along a ball mount axis and characterized by a rectangular cross-section, comprising:
A. a platform element having a substantially planar upper surface portion and a substantially planar lower surface portion, wherein the upper surface portion overlies the lower surface portion, and
B. a coupling assembly extending from the lower surface portion and defining an aperture extending along a platform axis substantially parallel to the lower surface portion, wherein the aperture is characterized by a substantially rectangular cross-section transverse to the platform axis, and
wherein the aperture cross-section is substantially similar to the shank cross-section, and whereby the coupling assembly is selectively, slidably positionable over and about the shank with the platform axis substantially parallel with the ball mount axis.

2. A step platform according to claim 1, wherein the coupling assembly includes:
A. a first extension bracket extending from and perpendicular to the lower surface portion to a distal end, and having a substantially planar first principal surface,
B. a second extension bracket extending from and perpendicular to the lower surface portion to a distal end, and having a substantially planar first principal surface, wherein the first principal surface of the first extension bracket is opposite the first principal surface of the second extension bracket, and the distal end of the first extension bracket and the distal end of the second extension bracket are equidistant from the lower surface portion, and
C. a transverse bracket having a substantially planar first principal surface spanning the distal end of the first extension bracket and the distal end of the second extension bracket,
whereby the first principal surface of the first extension bracket, the first principal surface of the second extension bracket, and the first principal surface of the transverse bracket and the lower surface portion define the aperture.

3. A ball mount step platform, wherein the ball mount includes a shank having a distal insertion end and a proximal ball mount end, comprising:
A. a rigid, shaped platform element having a top surface and a bottom surface extending along a horizontal axis HA, wherein the shaped platform portion includes a protruding end and a flush end;
B. two extension brackets attached to the bottom surface, and extending along a bracket axis BA substantially perpendicular to the horizontal axis HA; and
C. a third connector bracket extending between and connected to the two extension brackets, and substantially perpendicular thereto, defining an aperture configured to receive therethrough a ball mount shank, wherein the aperture of the step platform is slidable over the distal insertion end of the ball mount shank, whereby the distal end protrudes a distance beyond the aperture when the platform is positioned thereon.

4. The step platform of claim 3, wherein the shaped platform is substantially in the shape of a half-circle.

5. The step platform of claim 3, wherein the top surface is a grip-enhancing surface.

6. The step platform of claim 3, wherein at least one of the extension brackets is integral with the bottom surface.

7. The step platform of claim 3, wherein at least one of the extension brackets is hingeably attached to the bottom surface.

8. The step platform of claim 3, wherein the connector bracket is integral with at least one of the extension brackets.

9. The step platform of claim 3, wherein the securing means includes at least one screw aperture extending through at least one extension bracket.

10. The step platform of claim 3, wherein the top surface is concave.

11. The step platform of claim 3, wherein the flush end is straight along a flush axis FA substantially perpendicular to the horizontal axis HA.

12. The step platform of claim 3, further comprising means for securing the platform to the ball mount shank.

13. A rigid, shaped step platform mountable on a ball mount shank, having a predetermined external cross-section dimension and shank shape, comprising:
A. a shaped step element having a top surface and a bottom surface,
wherein the shaped step element includes a protruding end and a flush end extending along a horizontal axis HA;
wherein the step platform is formed from a single, correspondingly-shaped block of rigid material; and
B. a bore hole extending through the block along the horizontal axis HA, wherein the bore hole has an internal cross-section dimension and bore hole shape approximately correlating to an external cross-section dimension and shank shape of the ball mount shank.

14. The step of claim 13, wherein the bore hole internal cross-section dimension is greater than the ball mount external cross-section dimension, further comprising an adapter device positioned in the bore hole for securing the step on the ball mount shank.

15. A step assembly fixedly attached to a ball mount assembly, comprising:
A. a shaped step element having a top surface and a bottom surface;
B. a ball mount assembly, having a top surface and a bottom surface,
wherein the ball mount assembly includes:
(i) a ball mount shank extending along a horizontal axis, having a distal insertion end and a proximal mount end; and
(ii) a ball mount element attached to the ball mount shank proximal mount end, and extending along the horizontal axis;
wherein the shaped step element bottom surface is fixedly attached to the ball mount assembly top surface and at least one of the ball mount shank and the ball mount element, along an axis transverse the horizontal axis, and
wherein the shaped step element is positioned on the ball mount assembly in a location that does not interfere with full utility of the ball mount assembly.
